(19) United States
(12) Patent Application Publication
(10) Pub. No.: US 2005/0265509 A1
(43) Pub. Date: Dec. 1, 2005

(54) Reactor pressure vessel cover for a boiling water reactor

(75) Inventors: Bernhard Hubner, Mannheim (DE); Klaus Benitz, Absteinach (DE)

Correspondence Address: LERNER AND GREENBERG, PA, P O BOX 2480, HOLLYWOOD, FL, 33022-2480, US

(73) Assignee: Westinghouse Electric Germany GmbH

(21) Appl. No.: 11/138,236

(22) Filed: May 25, 2005

(30) Foreign Application Priority Data
May 25, 2004 (DE) 10 2004 025 585.7

(51) Int. Cl. G21C 7/32

(52) U.S. Cl. 376/210

(57) ABSTRACT

A reactor pressure vessel cover for a boiling water reactor having a cover cooling system has at least one cover spray head disposed on the side facing the interior of the reactor. The cover spray head is fixed to a connector on the reactor pressure vessel cover, through which connector the cooling water of the cover cooling system can be supplied to the at least one cover spray head. The cover spray head is detachably connected to the connector, in that there is a sealing device at the connecting point between the cover spray head and the connector, by which the emission of cooling water into the interior of the reactor is avoided. In addition, with an antirotation device, the position of the cover spray head is prevented from rotating about an imaginary longitudinal axis of the connector.

### BACKGROUND OF THE INVENTION

Field of the Invention

The invention relates to a reactor pressure vessel cover for a boiling water reactor. The reactor pressure vessel cover has a cover cooling system which has at least one cover spray head disposed on a side facing an interior of the reactor. The cover spray head is fixed to a connector assigned to it on the reactor pressure vessel cover, through which connector the cooling water of the cover cooling system can be supplied to the cover spray head.

It is generally known that, in the case of boiling water reactors, cover cooling systems for the reactor pressure vessel cover are used in order to keep the thermal loading of the reactor pressure vessel cover as low as possible during specific transient states of the reactor, in particular when shutting down.

One configuration of such a cover cooling system has a number of connectors, to which cover spray heads are fitted, on the side of the reactor pressure vessel cover facing the interior of the reactor. The connectors have threads, onto which what are known as spray heads are screwed. However, the cooling water supplied to the cover spray head through the connectors is not intended to reach the interior of the reactor via the screw connection. In addition, it must be possible for the cover spray head screwed on to be fixed in a specific envisaged position. In the case of the cover spray heads that have been disclosed, this is achieved in that the screw connection between the connector and the cover spray head is welded tight with a welded connection.

It has transpired that, after a specific operating time and because of the mechanical and thermal, in particular also transient, stressing of the materials in this region, fatigue phenomena of the material have occurred.

### SUMMARY OF THE INVENTION

It is accordingly an object of the invention to provide a reactor pressure vessel cover for a boiling water reactor which overcome the above-mentioned disadvantages of the prior art devices of this general type, in which the fatigue phenomena do not occur or occur at a later time than previously, and in which reactor pressure vessel cover simpler replacement of cover spray heads is additionally made possible.

With the foregoing and other objects in view there is provided, in accordance with the invention, a reactor pressure vessel cover for a boiling water reactor having a cover cooling system. The reactor pressure vessel cover contains a connector, and at least one cover spray head disposed on a side facing an interior of the boiling water reactor. The cover spray head is detachably connected to the connector, and through the connector, cooling water of the cover cooling system can be supplied to the cover spray head. A sealing device is disposed at a connecting point between the cover spray head and the connector. The sealing device prevents an emission of the cooling water into the interior of the boiling water reactor. An antirotation device is provided and prevents a rotation of the cover spray head from rotating about an imaginary longitudinal axis of the connector.

Accordingly, the reactor pressure vessel cover according to the invention is characterized in that the cover spray head is detachably connected to the connector assigned to it. In addition, there is a sealing device at the connecting point between the cover spray head and the connector assigned to it, by which sealing device the emission of cooling water into the interior of the reactor is avoided. Furthermore, an antirotation device is provided, by which, the position of the at least one cover spray head is prevented from rotating about an imaginary longitudinal axis of the connector assigned to it.

The individual technical functions of the connection between a connector and the cover spray head are implemented by different technical components, particularly sealing against the emergence of cooling water and the antirotation safeguard against undesired rotation of the cover spray head relative to the connector. In this way, the separated functions can advantageously also be optimized individually. As a result, mutual disadvantageous effects as a result of individual technical measures but which exert a dual technical function is prevented. An advantageous increase in the lifetime of the connecting point therefore depends only on the optimization of the individual technical requirements of the functions, which are to be considered separately. In this way, the construction of the connecting point no longer has a basic lifetime restriction predefined. In addition, weak points detected quite specifically, for example mechanical ones of the connection between the connector and the cover spray head, can be eliminated in a simple way by appropriate measures, for example constructional ones, without interacting with other requirements.

An advantageous development of the reactor pressure vessel cover according to the invention is characterized in that the connection between the connector and the cover spray head assigned to it is a flange configuration. A preferred flange configuration generally contains two flanges. The first flange is in this case connected to the connector, for example by being welded to it. The welded connection on its own has the task of bearing the mechanical and thermal loadings at this point. The welded connection can thus be optimized particularly well for this purpose.

A second flange of the flange configuration is connected in a corresponding manner to the cover spray head, for example likewise welded on. The welded seam can also be optimized particularly simply, in accordance with the thermal and mechanical requirements. A particular advantage of the flange configuration is also to be seen in the fact that the two flanges can be sealed with respect to each other in a simple manner, for example by a seal being interposed between the opposite ends of the two flanges.

A further advantage of the flange configuration is that the flanges have a greater maximum diameter of their connecting point than the two components, here the connector and the cover spray head, in the region in which the latter is connected to the second flange. In this way, the connecting point of the flange is also a mechanically non-critical region of the connection between cover spray head and connector.

With the flange configuration, an antirotation safeguard can also be implemented in a particularly simple way. For example, dowel pins in the flange disks of the flange configuration are suitable as the antirotation device. An advantageous development of the invention additionally provides for a fixing device, that is to say in particular the screws for connecting the flanges, to be configured such that they act simultaneously as the antirotation device. In an advantageous refinement, this can be at least one cutout in the first flange, at least one further cutout, which additionally has a thread, being disposed in the second flange. As a result of screwing the screws into the second flange, at the same time the rotation of the two flanges with respect to each other, as viewed in the peripheral direction, is securely prevented.

Other features which are considered as characteristic for the invention are set forth in the appended claims.

Although the invention is illustrated and described herein as embodied in a reactor pressure vessel cover for a boiling water reactor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, partially cut-away, perspective view of a detail of a reactor pressure vessel cover having a cover spray head according to the invention;

FIG. 2 is a diagrammatic, cross sectional view through a detail shown in FIG. 1;

FIG. 3 is an enlarged, sectional view of a region identified by “III” in FIG. 2; and

FIG. 4 is a diagrammatic, sectional view taken along the section plane IV-IV shown in FIG. 2.

### DESCRIPTION OF THE PREFERRED EMBODIMENTS

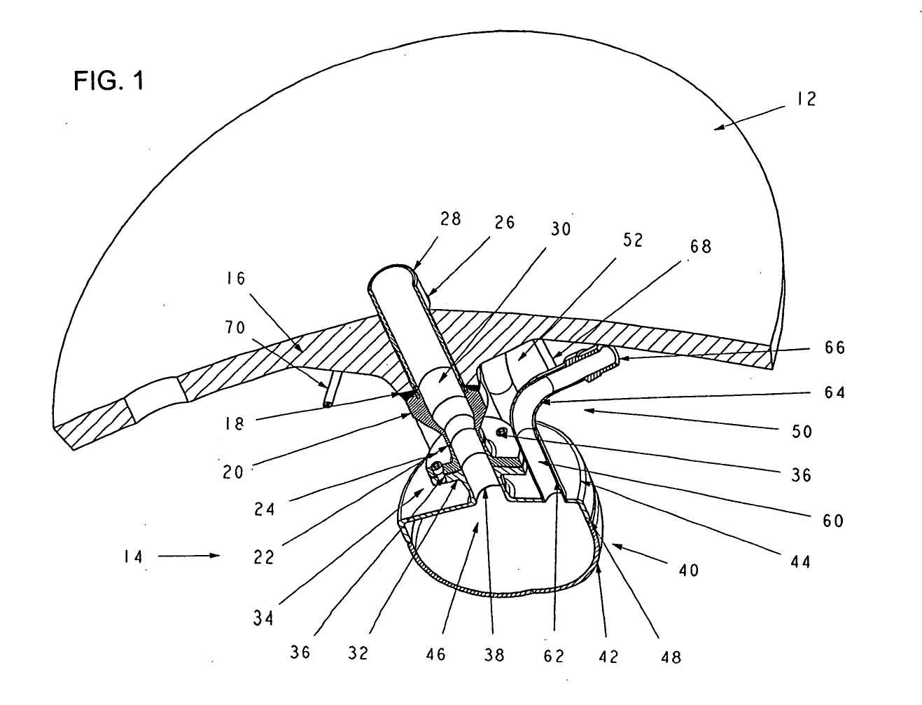

Referring now to the figures of the drawing in detail and first, particularly, to FIG. 1 thereof, there is shown a three-dimensional illustration of a detail of a reactor pressure vessel cover 12 in a region in which a cover spray head 14 is disposed. The reactor pressure vessel cover 12 has a thickening 16 at one point, at which a connector 20 is fitted by a first welded connection 18. A first flange 24 is connected to the connector 20 by a second welded connection 22.

The reactor pressure vessel cover 12 has a first cutout 26, through which a cooling water line 28 reaches and is led as far as the connector 20. In this case, a first end of the cooling water line, illustrated at the top in FIG. 1, is connected to a cover cooling system, which ensures the cooling water supply of the cover spray head 14 and of the further cover spray heads which are not illustrated in FIG. 1. The second end of the coolant line 28 is led as far as the region of the connecting point between the thickening 16 and the connector 20, so that the first welded connection 18 also connects the coolant line 28 to the connector 20 and to the reactor pressure vessel cover 12. The connector 20 has a second cutout 30, through which the cooling water coming from the cooling water line 28 is led onward as far as the first flange 24.

The first flange 24 is screwed to a second flange 32 by screws 36. In this case, the first flange 24 and the second flange 32 form what is known as a flange configuration 34 or else called a flange connection. The second flange 32 is connected to a spray head container 40 by a third welded connection 38 at its end facing away from the connector 20. The cooling water flowing in reaches the space formed by the cover spray head container 40 through the second flange 32.

The cover spray head container 40 is constructed in two parts, with a lower part 42, which is approximately pot-shaped, and with an upper part 44, which is constructed approximately in the shape of a pot lid which has a third cutout 46 approximately centrally. The second flange 32 is now disposed on the upper part 44 in such a way that the cooling water passes through the second flange 32 and through the third cutout 46 into the spray head container 40. The lower part 42 and the upper part 44 are connected by a fourth welded seam 48.

On its side facing the reactor pressure vessel cover 12, the upper part 44 has an approximately planar end face. Starting at a distance of about one third of the radius of the upper part 44 from the outer edge, five spray configurations are disposed distributed over the periphery, of which a first spray configuration 50 and a second spray configuration 52 can be seen in FIG. 1.

The first spray configuration 50 has a tubular piece 60, which is disposed with a first end in FIG. 1 above a corresponding cutout in the upper part 44. A first portion 62 of the tubular piece 60 is a straight pipe element and is exactly perpendicular to the surface of the upper part 44. At a specific distance from the upper part 44, the first portion 62 is followed by a curved portion 64 of the tubular piece 60, which describes approximately an arc of 135° and is oriented radially outward in relation to the upper part 44. Disposed at a second end of the tubular piece 60 is a nozzle piece 66, which ensures that the cooling water fed to the nozzle piece 66 through the spray head container 40 and through the tubular piece 60 is sprayed onto the reactor pressure vessel cover 12.

The second 52 of the five spray configurations can still be seen in FIG. 1 but is substantially in the background of FIG. 1, so that only a small detail of the second spray configuration 52 is visible. The first 50 and the second spray configurations 52 are connected to a first connecting rod 68 in the region of the nozzle piece 66 and to each other in a corresponding region of the second spray configuration 52. In this example, the connection is produced by a welded connection. By use of corresponding further connecting rods 70, the further spray configurations, in each case the adjacent ones, are also connected to one another. A configuration of this type has proven to be particularly advantageous against possible oscillation excitation, for example on account of the cooling water flowing through.

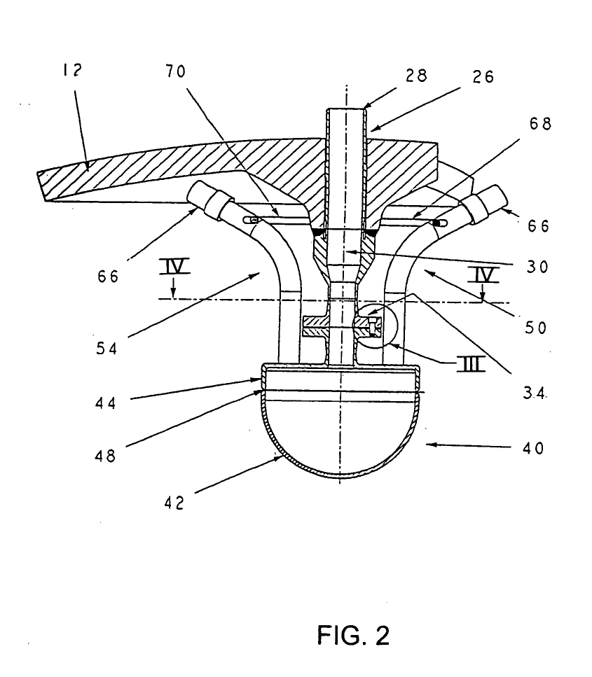

FIG. 2 shows a cross section through the detail according to FIG. 1. Accordingly, the designations that were introduced in FIG. 1 have been used for the corresponding components.

In FIG. 2, in addition to the first spray configuration 50, a third spray configuration 54 is shown, while the second spray configuration 52 visible in FIG. 1 is hidden in this view exactly behind the configuration of the reactor pressure vessel cover 12, the cooling water line 28, the connector 20, the flange configuration 34 and the spray head container 40. In addition, besides the first connecting element 68, one of the further connecting elements 70 is shown, which shows the invisible second connecting element 70 that connects the invisible second spray configuration 52 to the second spray configuration 54.

In addition, it can easily be seen in FIG. 2 that the reactor pressure vessel cover 12 overall assumes a shape, at least in the region around the thickening 16, of approximately the surface of a section of a sphere.

It can additionally be seen in FIG. 2 that the cooling water line 28 leads the cooling water from outside the reactor pressure vessel, illustrated at the top in FIG. 2, through the second cutout 30 and through the flange configuration 34 into the spray head container 40. The complete arrangement of the cover spray head 14 is therefore disposed in an internal region of the reactor pressure vessel. The further course of the cooling water line 28 outside the reactor pressure vessel is not further illustrated. The cooling water system which feeds the cooling water, in particular deionized water, to the cooling water line 28, can be configured as a separate cooling water system with pumps, regulating and control devices. However, it is also conceivable for the cooling water system to branch the cooling water off from the primary reactor cooling system and to perform only the task of regulation and control with respect to the cooling water supply of the cover spray heads 14.

On account of the alignment of the nozzle pieces 66 and of the corresponding nozzle pieces of the third nozzle configuration 54, it is easy to see that cooling water emerging from the nozzle pieces 66 sprays a region around the thickening 16 of the reactor pressure vessel cover 12 predefined by the alignment of the nozzle pieces 66, specifically on the side of the reactor pressure vessel cover 12 facing the interior of the reactor. By an appropriate number of cover spray heads 14, which are disposed in a predefined pattern on the inside of the reactor pressure vessel cover 12, uniform cooling of the reactor pressure vessel cover 12 is ensured. The cooling measure is expedient in specific operating states of the reactor in order to keep the reduction in the lifetime of the reactor pressure vessel cover 12, as a thick-walled component with transient temperature loadings, as low as possible. The configuration of the cover spray heads 14 is suitable in particular for a boiling water reactor, since the region of the pressure container underneath the pressure container cover in this reactor type has steam applied to it and not cooling water, as is usual in the case of pressurized water reactors, so that additional possible cooling by cooling water sprayed on is advantageous for the operating states mentioned above.

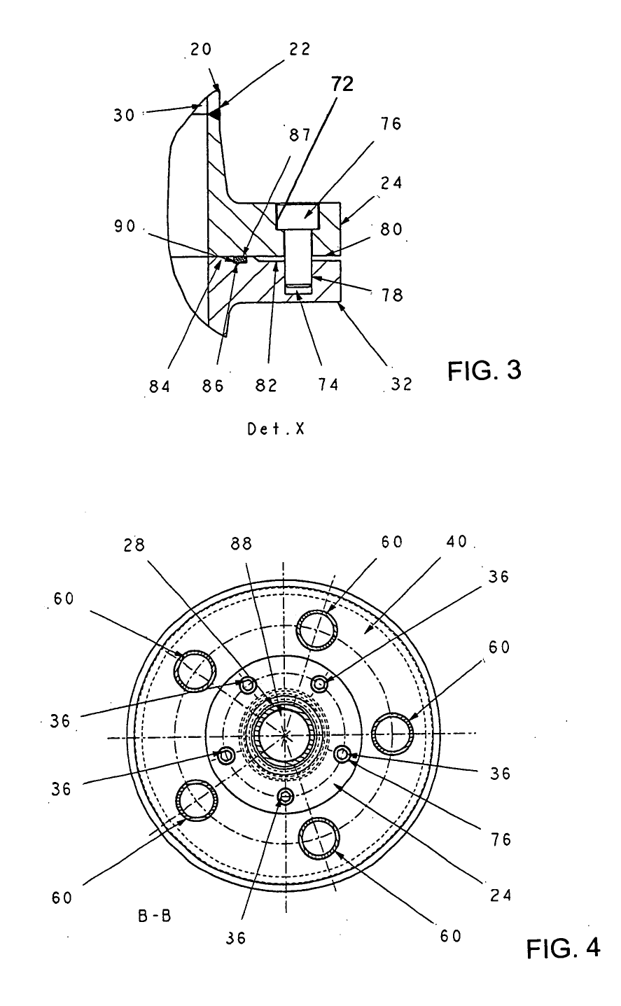

FIG. 3 shows an enlarged view of the region identified by “III” illustrated in FIG. 2. As previously, the designations that have already been introduced are taken over from the preceding figures. An enlarged region of the flange connection 34 having the first 24 and the second flange 32 is illustrated. In the following text, specific details which could not be illustrated in the figures mentioned previously are to be explained in more detail.

Arranged in the first flange 24 is a fourth cutout 72 which, in the example illustrated, is configured as a clearance hole, a first region, which faces away from the second flange 32, having a larger diameter than a second region, so that a screw 76 matched appropriately to the fourth cutout 72 can be countersunk into the fourth cutout 72 to precisely such an extent that, first, the screw head no longer projects beyond the corresponding end of the first flange 24 and, second, the underside of the screw head serves as a stop, so that the screw 76 inserted into the fourth cutout 72 is held securely in the fourth cutout 72. The second flange 32 has a fifth cutout 74 that is configured as a blind hole. The blind hole 74 has a thread 78, which is not specifically illustrated in FIG. 3. On the other hand, the screw 76, which is positioned in the fourth cutout 72 and is screwed into the thread 78 of the fifth cutout 74, is illustrated. With such an arrangement, rotation of the flanges 24, 32 with respect to each other is prevented and an antirotation safeguard is advantageously achieved.

The first flange 24 has a first end face 80 that is opposite a second end face 82 of the second flange 32. In the exemplary embodiment chosen, the first end face 80 is substantially planar, while the second end face 82 has a molding 84 in the inner region of the end face, as viewed radially. The molding itself is planar in the region in which it touches the first flange 24. The further region of the second end face 82 is spaced apart from the first end face 80 in accordance with the thickness of the molding 84. The screw 76 is also disposed in the further region. In this way, the screw 76 can ensure a plannable and secure screw connection with a predefined torque. In addition, the molding 84 has a sixth cutout 86, which is constituted as an annular groove in the end face of the molding 84. It is possible for a sealing device, which is illustrated as an O-ring 90 here, to be inserted into the sixth cutout 86.

However, it is also readily conceivable for the function of the molding 84 to be performed by a metallic sealing ring, which can likewise, at least partly, be inserted into a corresponding annular groove. The molding 84 can then even be dispensed with, if appropriate.

Furthermore, it can easily be gathered from FIG. 3 that, by the constructional measure according to the invention, a first physical region of the connection between the cover spray head 14 and the connector 20 for the sealing measure against the emergence of cooling water is provided and can be optimized, while another physical region on the flange connection 34 performs the antirotation safeguard, while the purely mechanical connection of the first flange 24 is produced via the second welded connection 22, and the flanges 24, 32 are connected to each other by the screw 76.

FIG. 4 shows a sectional illustration along the section plane IV-IV shown in FIG. 2. The designations have again been taken over from the preceding figures, as previously. In this case, FIG. 4 is illustrated symmetrically about an imaginary line of symmetry or center line 88 of the connector 20 which, in the example chosen, also coincides with the longitudinal axis of the coolant line 28. In addition, the illustration has been made from a view from above, that is to say from the viewing direction of the reactor pressure container cover 12.

In FIG. 4, screws 36, of which one was designated screw 76 in FIG. 3, or their screw heads are visible from above. This shows that, in the example chosen, the screws 36 are screwed in from the side of the reactor pressure vessel cover 12. This has the advantage that the distance between the second flange 32 and the spray head container 40 can be chosen to be particularly short. On the other side, namely the distance between the first flange 24 and the reactor pressure vessel cover 20, is comparatively large, so that there is sufficient space to screw in the screws and, at the same time, it is possible to comply with a constructional dimension defined by the approval process, namely a maximum distance between the reactor pressure vessel cover 12 and the spray head container 40.

In addition, it is easy to see in FIG. 4 that the position of the screws 36 and the positions of the tubular pieces 60, as viewed in the peripheral direction, are offset with respect to one another. The advantage in this case resides in a particularly simple mounting of the screws 36, which are particularly easily accessible on account of the arrangement chosen.

This application claims the priority, under 35 U.S.C. § 119, of German patent application No. 10 2004 025 585.7, filed May 25, 2004; the entire disclosure of the prior application is herewith incorporated by reference.

1. A reactor pressure vessel cover for a boiling water reactor having a cover cooling system, comprising:
a connector;
at least one cover spray head disposed on a side facing an interior of the boiling water reactor, said cover spray head being detachably connected to said connector, and through said connector cooling water of the cover cooling system can be supplied to said cover spray head;
a sealing device disposed at a connecting point between said cover spray head and said connector, said sealing device preventing an emission of the cooling water into the interior of the boiling water reactor; and
an antirotation device for preventing a rotation of said cover spray head from rotating about an imaginary longitudinal axis of said connector.

2. The reactor pressure vessel cover according to claim 1, wherein the cover cooling system is connected to a primary cooling water system of the boiling water reactor.

3. The reactor pressure vessel cover according to claim 1, further comprising at least one spray nozzle disposed on said cover spray head.

4. The reactor pressure vessel cover according to claim 1, wherein said connector has a truncated cone shape.

5. The reactor pressure vessel cover according to claim 1, further comprising:
a tubular piece having a first end and a second end; and
at least one spray nozzle disposed at said first end of said tubular piece, the cooling water from the cover cooling system can be led to said tubular piece of said spray nozzle from said second end of said tubular piece.

6. The reactor pressure vessel cover according to claim 4, further comprising:
stabilization elements; and
at least two tubular pieces with spray nozzles are disposed on said cover spray head, said tubular pieces are connected to their adjacent said tubular pieces, as viewed in a peripheral direction of said cover spray head, by said stabilization elements.

7. The reactor pressure vessel cover according to claim 5, wherein said spray nozzle is aimed at the reactor pressure vessel cover, at a near region around said connector.

8. The reactor pressure vessel cover according to claim 3, further comprising:
a cooling water feed line disposed on said cover spray head; and
a spray head container is interposed between said cooling water feed line and said spray nozzle.

9. The reactor pressure vessel cover according to claim 1, wherein said sealing device contains a flange configuration forming a connection between said connector and said cover spray head.

10. The reactor pressure vessel cover according to claim 9, wherein said flange configuration has a first flange connected to said connector.

11. The reactor pressure vessel cover according to claim 10, wherein said flange configuration has a second flange connected to said cover spray head.

12. The reactor pressure vessel cover according to claim 11, wherein said first and second flanges have ends that are disposed opposite to each other and function as a seal for sealing against an emergence of the cooling water into the interior of the boiling water reactor.

13. The reactor pressure vessel cover according to claim 11, further comprising a seal interposed between said first and second flanges.

14. The reactor pressure vessel cover according to claim 11, wherein said antirotation device is at least one fixing device of said flange configuration.

15. The reactor pressure vessel cover according to claim 14, wherein said fixing device can be fed in from an end of said first flange that faces said connector.

16. The reactor pressure vessel cover according to claim 14, wherein said second flange has cutouts with holding elements formed therein for receiving and holding said fixing device.

17. The reactor pressure vessel cover according to claim 14,
further comprising a tubular piece having a first end and a second end;
further comprising a spray nozzle disposed at said first end of said tubular piece, the cooling water from the cover cooling system can be led to said tubular piece of said spray nozzle from said second end of said tubular piece; and
wherein said fixing device, as viewed in a peripheral direction of said flange configuration, is disposed to be offset in relation to said spray nozzle or said tubular piece assigned to said spray nozzle.

18. The reactor pressure vessel cover according to claim 10, wherein said first flange is welded to said connector.

19. The reactor pressure vessel cover according to claim 11, wherein said second flange is welded to said cover spray head.

20. The reactor pressure vessel cover according to claim 13, wherein said seal is a metallic seal.

21. The reactor pressure vessel cover according to claim 14, wherein said fixing device is a screw.

22. The reactor pressure vessel cover according to claim 16, wherein said holding elements are threads.
